(19) United States
(12) Patent Application Publication
(10) Pub. No.: US 2022/0170312 A1
(43) Pub. Date: Jun. 2, 2022

(54) BLENDED WOOD INTERIOR DOOR JAMB

(71) Applicant: William-MacRae and Company, Omaha, NE (US)

(72) Inventor: Colin MacRae Thomson, Issaquah, WA (US)

(21) Appl. No.: 17/540,831

(22) Filed: Dec. 2, 2021

Related U.S. Application Data
(60) Provisional application No. 63/120,527, filed on Dec. 2, 2020.
(60) Provisional application No. 63/142,079, filed on Jan. 27, 2021.

(51) Int. Cl. E06B 1/06; B32B 21/04; B32B 21/13; B32B 21/14; B32B 21/02; B32B 7/12; B32B 37/12

(52) U.S. Cl. CPC E06B 1/06; B32B 21/042; B32B 21/13; B32B 21/14; B32B 2250/02; B32B 7/12; B32B 37/12; B32B 2307/732; B32B 2419/00; B32B 21/02

(57) ABSTRACT

A blended trim molding assembly can include a first layer of engineered wood material (e.g., medium-density fiberboard) having a first, generally rectangular cross-sectional thickness, and a second layer of wood material (e.g., lumber, particle board, fiberboard) having a second, generally rectangular cross-sectional thickness. The second layer of wood material is joined (e.g., glued) to the first layer of engineered wood material at a planar interface. Together, the first and second layers have a total thickness, with the first cross-sectional thickness being greater than or equal to at least about ten percent (10%) of the total thickness of the first and second layers. The blended trim molding assembly may also include a third layer of wood material having a third, generally rectangular cross-sectional thickness, where the third layer of wood material is joined to the first layer of engineered wood material at a second planar interface opposite the planar interface.

### CROSS-REFERENCE TO RELATED APPLICATIONS

The present application claims the benefit under 35 U.S.C. § 119(e) of U.S. Provisional Application Ser. No. 63/120,527, filed Dec. 2, 20020, and titled “DUAL-LAYERED WOOD INTERIOR DOOR JAMB,” and U.S. Provisional Application Ser. No. 63/142,079, filed Jan. 27, 2021, and titled “BLENDED WOOD INTERIOR DOOR JAMB,” which are herein incorporated by reference in their entireties.

### BACKGROUND

Interior woodwork for buildings, such as residential and commercial housing, includes trim moldings, such as casings used to trim the perimeter of windows, doors, and so forth. For example, a doorframe can include case molding in the form of two upright jambs. A door can be hung on one of the upright jambs. Base molding can be applied where a wall meets the floor of a structure.

### DRAWINGS

The Detailed Description is described with reference to the accompanying figures. The use of the same reference numbers in different instances in the description and the figures may indicate similar or identical items.

FIG. 1 is a partial isometric view illustrating blended trim molding for an interior door jamb in accordance with example embodiments of the present disclosure.

FIG. 2 is an obverse isometric view of the blended trim molding illustrated in FIG. 1.

FIG. 3 is a top plan view of the blended trim molding illustrated in FIG. 1.

FIG. 4 is a bottom plan view of the blended trim molding illustrated in FIG. 1.

FIG. 5 is a front elevation view of the blended trim molding illustrated in FIG. 1.

FIG. 6 is a rear elevation view of the blended trim molding illustrated in FIG. 1.

FIG. 7 is a left side elevation view of the blended trim molding illustrated in FIG. 1.

FIG. 8 is a right side elevation view of the blended trim molding illustrated in FIG. 1.

FIG. 9 is an end view illustrating blended trim molding in accordance with example embodiments of the present disclosure.

FIG. 10 is a partial isometric view illustrating blended trim molding for an interior door jamb that includes dado and hinge cutouts in accordance with example embodiments of the present disclosure.

FIG. 11 is an isometric view illustrating trim moldings, such as the blended trim molding illustrated in FIG. 1, configured as a door jamb set and installed in a rough opening in accordance with example embodiments of the present disclosure.

FIG. 12 is a partial perspective view illustrating blended trim molding in accordance with example embodiments of the present disclosure.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. The following detailed description is, therefore, not to be taken in a limiting sense.

Interior millwork for residential and commercial housing are decorative, nonstructural components normally made of strips of wood and used to cover transition areas between surfaces. These components, called “mouldings” or “moldings,” include casings/case moldings, base moldings, and crown moldings, and can be used to trim the perimeter of windows, doors, and locations where walls meet a floor or a ceiling. Vertical and horizontal millwork trim pieces that cover door openings are called door jambs. Vertical door jambs bear the weight of the door through applied hinges and latches. Two vertical jamb sides and a head jamb may be referred to as a door jamb set. A door jamb set hinged to a door may be referred to as a prehung door. The accuracy of the plumb and strength of a door jamb is important to the overall operational durability and security of a door. Today, millwork also encompasses items that are made using alternatives to wood, including synthetics, plastics, and wood-adhesive composites. Millwork may be painted or stained (e.g., after installation).

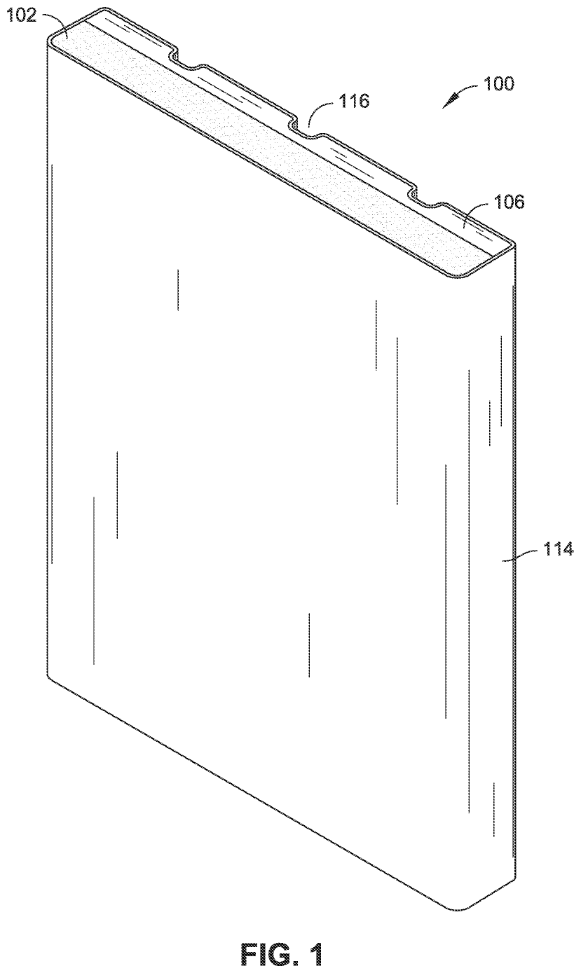

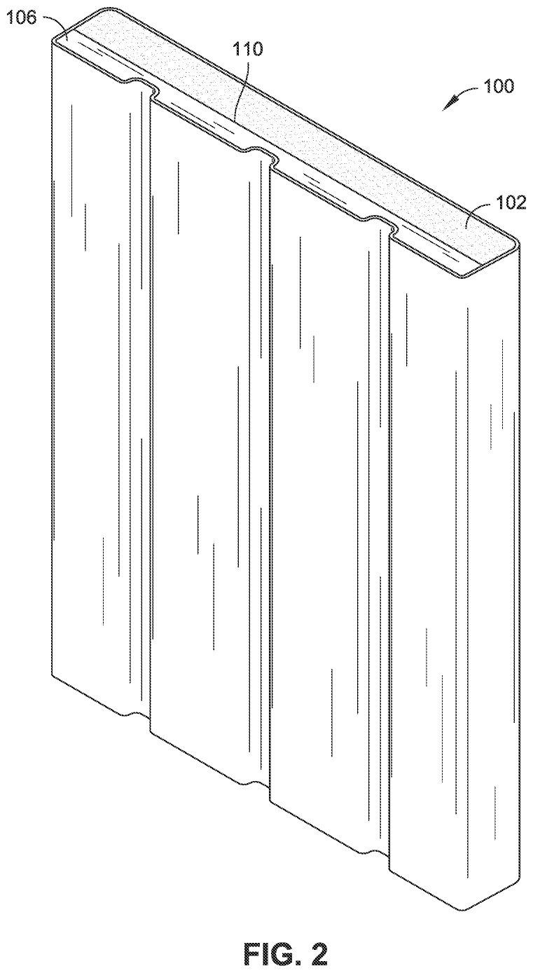

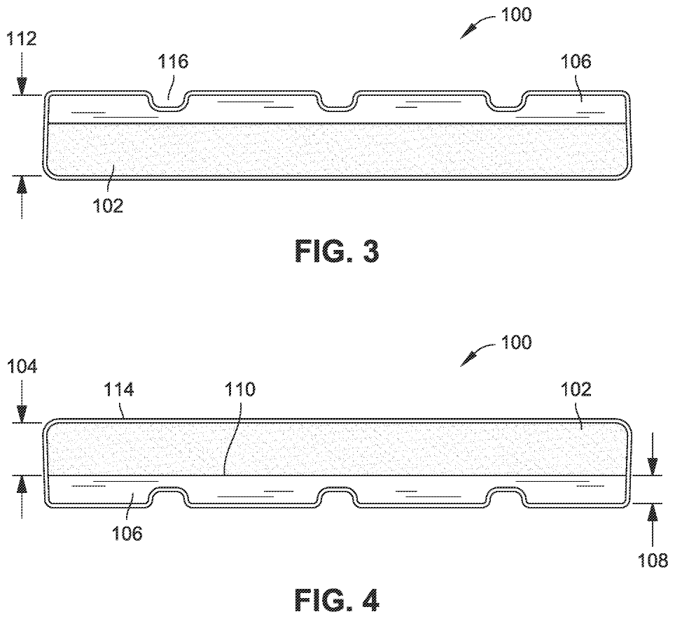

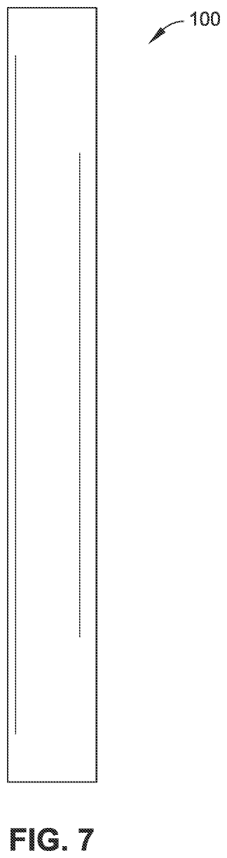

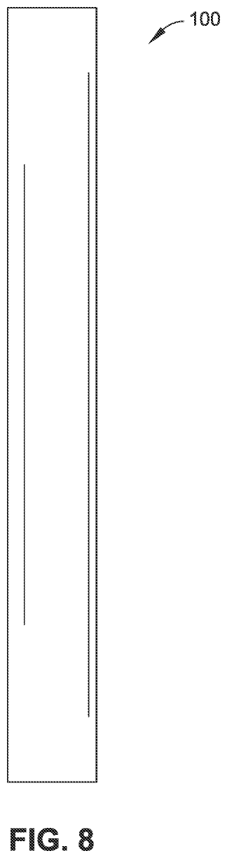

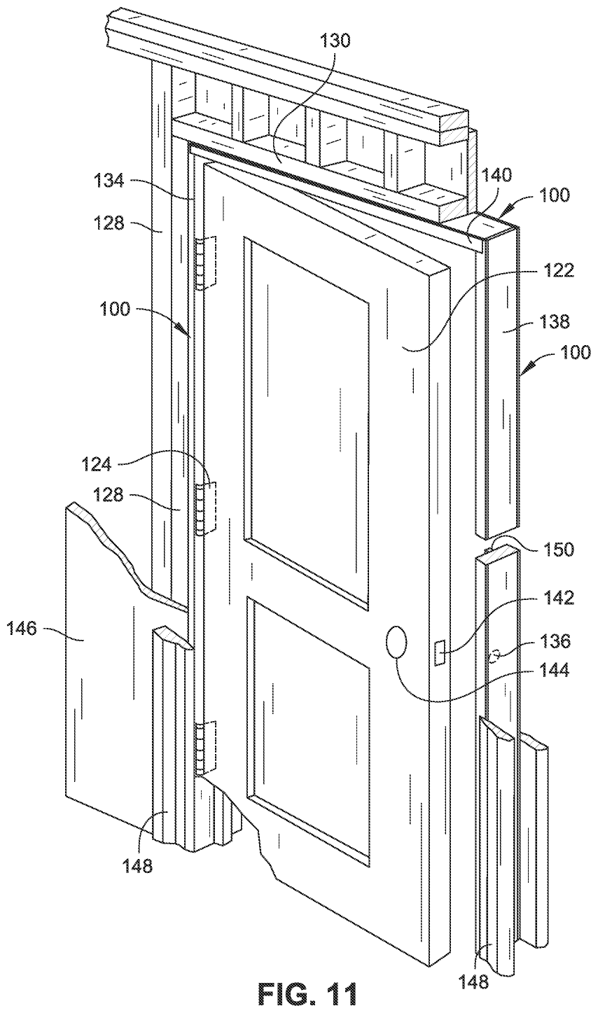

Referring generally to FIGS. 1 through 12, blended (e.g., dual-layered) trim molding assemblies, such as door jamb assemblies 100 for a door jamb set are described. For example, a door jamb assembly 100 can be configured as a flat door jamb. A door jamb assembly 100 can include a first layer 102 of engineered wood material having a first, generally rectangular cross-sectional thickness 104, and a second layer 106 of wood material having a second, generally rectangular cross-sectional thickness 108. In embodiments of the disclosure, the second layer 106 is connected (e.g., bonded, joined) to the first layer 102 at a planar interface 110. Together, the first layer 102 and the second layer 106 have a total thickness 112. As described herein, the first, generally rectangular cross-sectional thickness 104 may be greater than or equal to at least about ten percent (10%) of the total thickness 112 of the first layer 102 and the second layer 106. In some embodiments, the first, generally rectangular cross-sectional thickness 104 can be greater than or equal to about fifty percent (50%) of the total thickness 112. For instance, the first, generally rectangular cross-sectional thickness 104 can be greater than about sixty percent (60%) of the total thickness 112, greater than about eighty percent (80%) of the total thickness 112, and so on.

In some embodiments, the second layer 106 of wood material is glued (e.g., using an adhesive binder or another adhesive) to the first layer 102 of engineered wood material at the planar interface 110. A press or other equipment may be used to force the first and second layers 102 and 106 together during the gluing process. In some embodiments, the first layer 102 of engineered wood material can be medium-density fiberboard (MDF), fiberboard, hardboard, particle board, wafer board, oriented strand board, and/or other engineered wood panel materials. The first layer 102 of engineered wood material can be formed by combining at least about eighty percent (80%) cellulosic wood, grass, or other ligneous materials of irregular size and shape, such as fibers, shavings, chips, dust and shavings, whether or not agglomerated with glue or other binding substances.

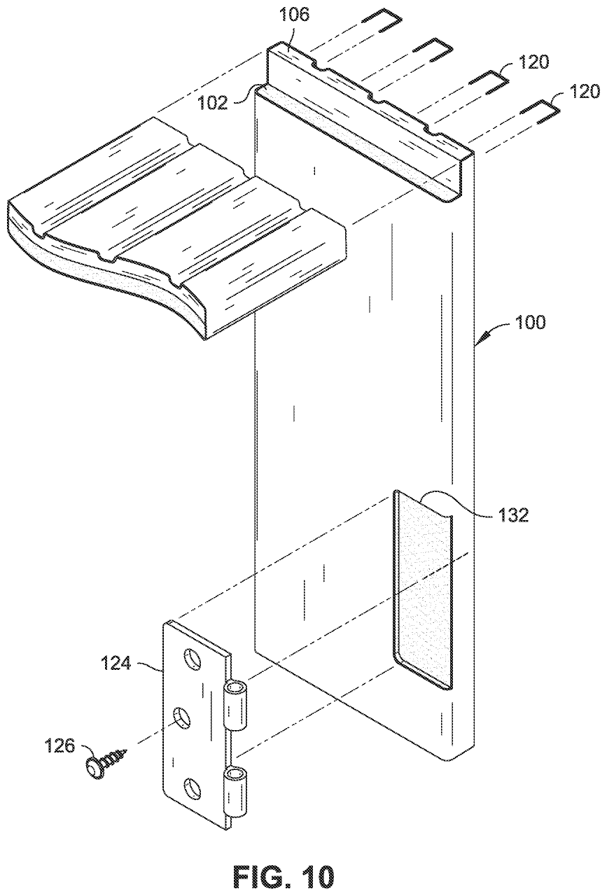

In some embodiments, the second layer 106 of wood material can be laminated lumber, e.g., laminated veneer lumber (LVL). The second layer 106 of wood material can also be milled lumber material (e.g., pine wood). In some embodiments, the second layer 106 of wood material can include multiple segments fastened together (e.g., finger-jointed wood), particle board, fiberboard, and so forth. As described herein, the second layer 106 of wood material has superior screw pull strength to the first layer 102 of engineered wood material, and/or is more capable of securing staples 120 (FIG. 10) and/or other fasteners, such as nails, that connect the door jamb assembly 100 to, for example, a head jamb connected at a dado to a vertical jamb. Additionally, in the case of a milled lumber second layer 106, a first layer 102 of MDF may provide added dimensional stability to the door jamb assembly 100, e.g., lessening warp and/or twist found in all-wood jambs.

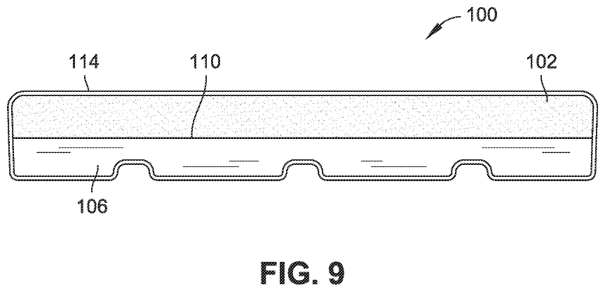

In some embodiments, the first layer 102 of engineered wood material can be MDF formed from a panel having a thickness of about nine millimeters (9 mm) and the second layer 106 of wood material can be LVL and/or finger-jointed pine wood formed from a panel or panels having a thickness of about eight millimeters (8 mm) (e.g., as described with reference to FIG. 9). The thicknesses of nine millimeters (9 mm) and eight millimeters (8 mm) for the first and second layers 102 and 106, respectively, are provided by way of example and are not meant to limit the present disclosure. For example, the first layer 102 can have a thickness between about three millimeters (3 mm) and about ten millimeters (10 mm), and the second layer 106 can have a thickness between about six millimeters (6 mm) and about thirteen millimeters (13 mm). After the first and second layers 102 and 106 are adhered together (e.g., as panels), one or more coatings of primer 114 can be applied to the assembled panels. In some embodiments, assembled panels can be cut (e.g., into strips) to form the door jamb assemblies 100. For example, assembled, laminated panels can be cut (e.g., ripped) into strips about five inches (5″) wide. Next, the strips may be run through a wood molder to form a shaped door jamb, coated with primer 114, and then dado cut. By way of example, a process for laminating the first layer 102 of engineered wood material and the second layer 106 of wood material together can include cleaning both surfaces of dust and debris, e.g., at surfaces that form the planar interface 110. Both surfaces can also be checked to ensure the surfaces to be joined are smooth and free of voids. Then, one or more of the surfaces to be joined can be coated with glue and/or another adhesive, and finally, even pressure can be applied to both materials, e.g., using a press or another pressing device.

As described herein, door jamb assemblies 100 can be used for interior doorway applications. For example, a door 122 can be attached to an interior door jamb assembly 100 by hinges 124 fastened to the door jamb assembly 100 by fasteners (e.g., screws 126) extending into the door jamb assembly 100. A door jamb assembly 100 can also include other hardware, such as a strike plate and so forth. A door jamb assembly 100 can be fastened to the doorframe by fasteners (e.g., nails) extending through a side of the door jamb assembly 100 and into the framing studs (e.g., jack stud 128) and/or header 130 of the doorframe. For example, a doorframe may be formed by a king stud 128 and a jack stud 128 on one side of the doorframe (with additional framing studs mirrored on the other side of the doorframe) and a header 130 at the top of the doorframe. The side of the door jamb set formed by a door jamb assembly 100 that attaches the hinges 124 can include hinge cutouts 132 and forms a hinge jamb 134. In other embodiments, the door jamb assembly 100 does not necessarily include the hinge cutouts 132. For instance, cutouts may be added during installation of the door 122. The other side of the door jamb set formed by a door jamb assembly 100 that attaches the strike plate can include a mortise 136 (e.g., for the strike plate) and forms a latch jamb 138. The top of the door jamb set formed by a door jamb assembly 100 forms a head jamb 140. The door can include a latch bolt bore 142 for a latch bolt to interface with the strike plate/mortise 136 and a lockset bore 144. After the door jamb set is anchored to the rough opening, finishes such as drywall 146 and casings 148 can be added to complete the installation.

The first layer 102 of engineered wood material can be formed of a composite material (e.g., engineered wood formed from wood dust (e.g., sawdust), shavings, fibers, fillers, etc.) and shaped into a flat jamb. In some embodiments, the first layer 102 of engineered wood material may also include one or more surface features, such as a stop 150. In embodiments of the disclosure, the first layer 102 of engineered wood material can be a flat panel of engineered wood material. For example, in some embodiments, the first layer 102 of engineered wood material can be molded cellulosic fiberboard, which can be formed from a pre-consolidated mat. The pre-consolidated mat can be formed into consolidated medium-density fiberboard (MDF), hardboard, softboard, low-density fiberboard, and so forth. For instance, hardwood and/or softwood residuals can be broken down into fillers or fibers (e.g., using a defibrator or another pulping machine, grinding, explosion hydrolysis, etc.), and the resulting wood fillers or fibers can be formed into a loose mat along with a binding agent and/or resin and/or wax and compressed under high temperature and pressure to form a first layer 102 of engineered wood material.

In some embodiments, the pre-consolidated cellulosic mat may be planar. However, when molded to form the first layer 102 of engineered wood material, various shaped molds may be used to form surface features (e.g., an embossed texture, such as a faux wood grain pattern surface texture) and/or contours (e.g., an interior extension or depression, such as stop 150). In some embodiments, a first layer 102 of engineered wood material may also have one or more smooth exterior surfaces. Further, the edges and/or sides of the door jamb assembly 100 may include various edge details, including, but not necessarily limited to: back beveled details, square details, trim guide details, and so on. For instance, edge details may be provided for resting and/or registering the casing 148. As described, the first layer 102 of engineered wood material may have a generally rectangular cross-sectional thickness.

In some embodiments, the pre-consolidated cellulosic mat can be formed in a wet process, e.g., where cellulosic fillers or fibers in a slurry having a high moisture content (e.g., about ninety percent (90%) water or more by weight) and a synthetic resin binder (e.g., phenol-formaldehyde resin) are deposited onto a water permeable support (e.g., a fine screen, mesh, wire, etc.). Moisture is then removed to leave a wet mat of cellulosic material having a lower moisture content (e.g., about fifty percent (50%) water by weight). The wet mat can then be molded under high temperature and pressure to form the composite first layer 102 of engineered wood material. In some embodiments, the pre-consolidated cellulosic mat can be formed in a wet-dry process, e.g., where a large amount of moisture from a wet mat is evaporated prior to molding (e.g., leaving the mat with a water content of about ten percent (10%) or less by weight). Further, a pre-consolidated cellulosic mat can be formed in a dry process, e.g., where cellulosic fibers are conveyed mechanically or in a gas stream rather than in a liquid. For example, cellulosic fibers may be coated with thermosetting resin binder (e.g., phenol-formaldehyde resin) and formed into a mat by blowing the coated fibers onto a support.

In some embodiments, the first layer 102 of engineered wood material may be formed as a wood composite including lignocellulose/lignocellulosic fiber and a polymer resin. The term lignocellulose refers to plant dry matter (biomass) including carbohydrate polymers (cellulose, hemicellulose) and an aromatic polymer (lignin). The lignocellulose composite mixture may have about 70% to about 99% by weight lignocellulosic fiber. In some embodiments, the density of the first layer 102 may be between about three hundred kilograms per cubic meter (300 kg/m³) and about one thousand six hundred kilograms per cubic meter (1,600 kg/m³). The lignocellulosic fiber can have a range of moisture levels and may be dehydrated prior to treatment with the resin. For example, the lignocellulosic fiber can have from about 2% to about 20% moisture content by weight. In embodiments, the resin may be a formaldehyde-based resin, an isocyanate-based resin, and/or another thermoplastic or thermoset resin. In some embodiments, the amount of resin may range from about 1% to about 25% by weight of the composite. The lignocellulosic composite mixture may also include one or more waxes (e.g., a natural wax and/or a synthetic wax, such as paraffin wax, polyethylene wax, polyoxyethylene wax, microcrystalline wax, shellac wax, ozokerite wax, montan wax, emulsified wax, slack wax, etc.). The composites may also include a pre-press sealer (e.g., a liquid material applied to the surface of a mat used to formulate the composite prior to the mat entering a press). The lignocellulosic mixtures may be pressed into the first layer 102 using flat or molded dies at high temperature and/or pressure. The mixture may initially be formed into a loose mat then placed into a die press.

In some embodiments, a two-part mold, such as a die press (e.g., having a first die and a second die) may be used to form the first layer 102 of engineered wood material. For example, a pre-consolidated mat can be placed into the die press and formed into consolidated medium-density fiberboard (MDF), hardboard, softboard, low-density fiberboard, and so forth. As described, hardwood and/or softwood residuals broken down into fillers or fibers can be formed into a loose mat along with a binding agent and/or resin and/or wax and compressed under high temperature and pressure in the die press to form the first layer 102 of engineered wood material. In some embodiments, one or more walls of the first die and/or the second die may be formed with a negative camber or positive draft (e.g., for more easily releasing from the die press). For example, walls of the first die and/or the second die may slope outwardly and downwardly when viewed from an end, allowing the first layer 102 of engineered wood material to easily release from the dies after formation. In some embodiments, one or more walls of the first die and/or the second die may be formed with a zero camber or zero draft (e.g., at an angle of about ninety (90) degrees from an adjacent surface. In some embodiments, one or more walls of the first die and/or the second die may be formed with a positive camber or negative draft. For example, walls of the first die and/or the second die may slope inwardly and downwardly when viewed from an end, providing a back bevel.

In an example configuration where, for instance, walls of the first die and/or the second die are formed with a negative camber or positive draft and/or with a zero camber or zero draft, a back bevel and/or trim guide feature may be provided by a trimming or machining operation. For example, a back bevel and/or a trim guide may be provided by cutting, shaving, milling, or otherwise trimming material from the door jamb assembly 100 to thin the assembly from a first thickness to a second thickness. However, a trimming or machining operation is provided by way of example and is not meant to limit the present disclosure. In other embodiments, a die (e.g., first die and/or second die) may include a movable segment configured to form a feature that provides positive camber or negative draft. In this configuration, the movable segment may be positioned to create a feature with positive camber or negative draft (e.g., back bevels and/or notches). The movable segment may then be moved out of position to allow the first layer 102 of engineered wood material to release form the die press and the dies. It should also be noted that the ends of a first layer 102 of engineered wood material formed from a pre-consolidated cellulosic mat may be rough after manufacturing, and the ends may be trimmed (e.g., machined, milled) after the first layer 102 of engineered wood material has been formed in the die press.

However, a pre-consolidated cellulosic mat is provided by way of example and is not meant to limit the present disclosure. In other embodiments, a pre-formed planar fiber board may also be molded to form a composite first layer 102 of engineered wood material. For instance, an MDF board may be heat treated to its softening point and then deformed in a press. In some embodiments, a first layer 102 of engineered wood material may also be corrugated (e.g., in the manner of cardboard). When the first layer 102 of engineered wood material is formed (e.g., using a wet process, a wet-dry process, a dry process, a fiber board process, or another process), various surface features and/or contours can be formed in the first layer 102 of engineered wood material using various mold or press features. For example, a first layer 102 of engineered wood material can be formed and textured using a mold or press with a complementary relief pattern that forms a wood grain pattern on one or more surfaces of the first layer 102 of engineered wood material. Additionally, a first layer 102 of engineered wood material can be formed of more than one molded or pressed composite material segment joined together (e.g., using an adhesive binder or another adhesive at contact points along mating surfaces of the engineered wood segments). Further, in some embodiments, a first layer 102 of engineered wood material can be formed using another process, such as extrusion. For example, the first layer 102 of engineered wood material may be formed using one or more extruded plastic materials, vinyl materials, polyvinyl chloride (PVC) materials, fiber glass materials, and so forth. In a similar manner to a molded material that forms a composite first layer 102 of engineered wood material, various surface features and/or contours may be formed in an extruded first layer 102 of engineered wood material (e.g., using various mold and/or press features).

Once the first layer 102 of engineered wood material has been formed under high temperature and pressure, different surface finishes and/or treatments may be applied to the first layer 102 of engineered wood material. For example, one or more layers of primer, paint, and/or stain can be applied to the surface of the first layer 102 of engineered wood material. An interior door jamb assembly 100 may be sold as a primed and ready-to-paint unit. In some embodiments, a veneer, such as a wood veneer, may also be applied to one or more surfaces of the first layer 102 of engineered wood material.

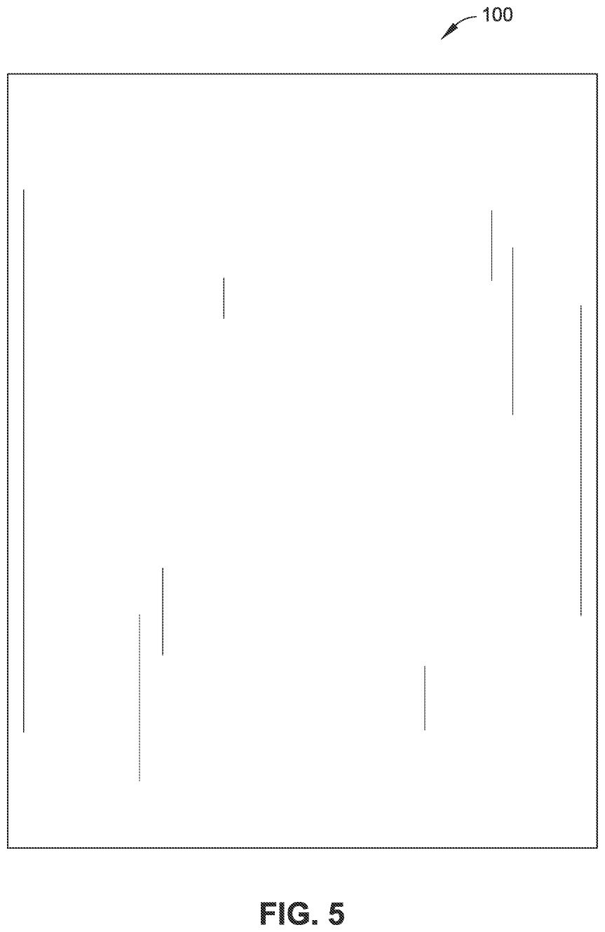

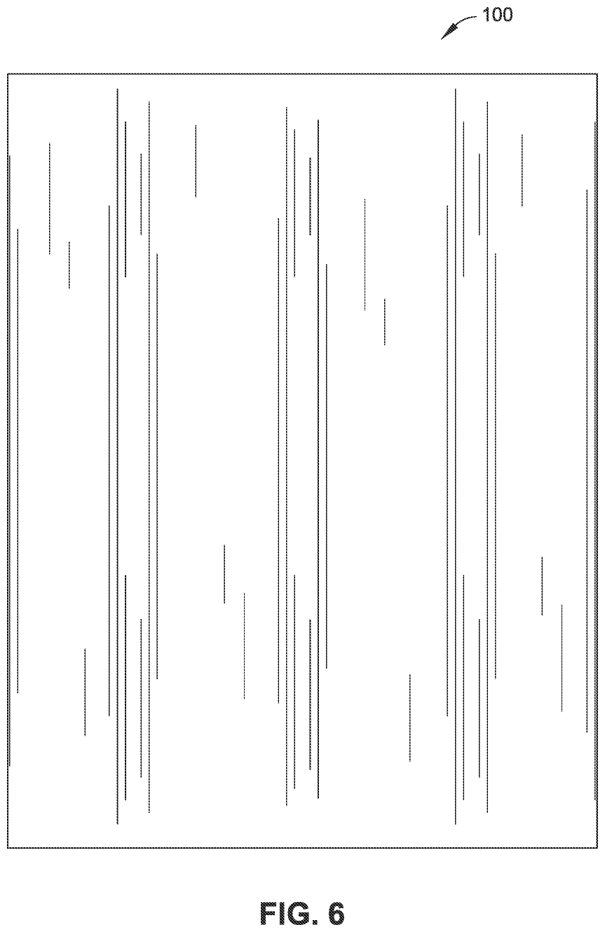

The second layer 106 can be formed of a wood material (e.g., scrap wood), a composite material (e.g., particle board (PB), plywood, laminated veneer lumber (LVL), wafer board, finger-jointed wood, and so forth) having a generally rectangular cross-sectional area. For example, the second layer 106 of wood material can be cut to fit and then glued to the first layer 102 of engineered wood material. In some embodiments, the second layer 106 of wood material can be a wood including, but not necessarily limited to: Radiata Pine, Poplar, Hemlock, Lauan, and so forth. In some embodiments, the density of the second layer 106 may be between about two hundred kilograms per cubic meter (200 kg/m³) and about seven hundred and fifty kilograms per cubic meter (750 kg/m³). It should be noted that because the outer first layer 102 of engineered wood material hides the inner second layer 106 of wood material, the second layer 106 may be rough and/or unfinished (e.g., not finely milled on all sides). For instance, the second layer 106 of wood material can be formed from edge glued blocks, finger jointed blocks (e.g., as described with reference to FIGS. 5 and 6), and so forth.

In some embodiments, the second layer 106 of wood material can be made of particle board. In some embodiments, the second layer 106 of wood material can be made of a laminated lumber, such as plywood. Further, in some embodiments, reinforcing blocks of a different material (e.g., milled lumber) can be positioned proximate to key areas of a jamb (e.g., behind a hinge 124). For example, milled lumber may have better screw holding ability compared to, for example, particle board, and milled lumber may be used behind a hinge 124 while particle board or another less expensive material is used for the remainder of the second layer 106 of wood material. In another example, plywood, LVL, or wafer board may have better screw holding ability and/or moisture resistance compared to particle board, and one or more of these materials (e.g., plywood, LVL, wafer board) may be used behind a hinge 124 while particle board and/or another less expensive material is used for the remainder of the second layer 106 of wood material. LVL, finger-jointed wood and/or other materials that exhibit dimensional stability may also be desirable for strategic positioning along the second layer 106 of wood material.

The techniques and apparatus of the present disclosure may provide for improved raw material utilization. For example, wood residuals, particle board, and/or MDF segments used for the second layer 106 of wood material may be milled from smaller sections of wood (e.g., as opposed to typical door jambs and stops, which are milled from larger sections of wood). Further, in embodiments where the second layer 106 of wood material has a generally rectangular cross-sectional profile, the second layer 106 of wood material may be cut from a standard thickness flat panel by sawing rather than by milling larger wood sections using, for instance, a molder.

The first layer 102 of engineered wood material can be made from wood fiber and can include small trees that would otherwise be too small to process into typical jambs and stops, as well as including branches, knots, and small and/or short wood scraps. Further, the composite first layer 102 of engineered wood material can be made from tree species not typically used in the manufacturing of door jambs (e.g., due to stability issues, size, abundance, and/or other factors). In some embodiments, a door stop can be nailed or stapled into the face of a door jamb through the face of the stop. For example, a door jamb assembly 100 may be formed with a flat jamb, and an additional stop 150 may be nailed onto the jamb. The holes are then filled prior to finishing (e.g., painting) the door jamb. In some embodiments, there are not necessarily holes through the stop 150 that are filled. Further, in the case of a molded stop as opposed to door jambs with a stop nailed to the jamb, there is also not a gap or a seam between the jamb and the stop 150, which would otherwise be caulked prior to finishing (e.g., painting) the jamb.

It should also be noted that the surface of a molded door jamb assembly 100 can be matched to the surface of, for example, a molded 6-panel door (e.g., having an MDF exterior). For instance, a door jamb assembly 100 can have a primer coat applied, which may be similar or comparable to the door mating to the door jamb assembly 100. The door jamb assembly 100 can also have a surface texture, such as an embossed wood grain pattern or another surface texture, similar to or comparable to the door mating to the door jamb assembly 100. Additionally, wood product defects in the exterior of the door jamb assembly 100, such as splits, tear outs, knots, pitch bleeds, resin bleeds, and the like may be reduced or eliminated using the systems, techniques, and apparatus disclosed herein. Furthermore, the incidence of typical wood distortion found in existing wood products, e.g., cupping, warping, twisting, crooking, and so forth, may be reduced or eliminated, e.g., due to the shape of the composite first layer 102 of engineered wood material, which can stabilize the second layer 106 of wood material. Further, in some embodiments, a second layer 106 of wood material may include structural features configured to further strengthen a door jamb assembly 100 and/or reduce or minimize dimensional distortion/cupping. For example, one or more features, such as longitudinal channels and/or grooves 116 may be formed in the second layer 106 of wood material (e.g., on a back side of the second layer 106 of wood material. In some embodiments, the grooves 116 may run the length of the second layer 106 of wood material.

Additionally, improved utilization of wood and/or reduction of material waste of wood over typical manufacturing may be achieved using the systems, techniques, and apparatus disclosed herein. Also, areas with an abundant wood fiber supply but a lesser supply of larger sections of wood for milling one-piece jamb parts can benefit from the ability to locally manufacture the door jamb assemblies 100 disclosed herein, incurring, for example, reduced shipping costs due to domestic production. It should also be noted that the defect rate may be reduced (e.g., in comparison to milling wood components) as described herein.

In some embodiments, the edges and/or sides of a door jamb assembly 100 may be back beveled, square, trim guide, and so forth. Further, the width of a door jamb assembly 100 can vary based upon, for instance, door opening size, wall thickness, and so forth. The shape of the stop 150 may also vary. For example, the stop 150 may be colonial shaped. In some embodiments, a stop 150 may also have square edges. However, these shapes are provided by way of example and are not meant to limit the present disclosure. In other embodiments, a stop 150 may have a different shape, including, but not necessarily limited to: a one-radius edge, a two-radius edge, and so forth. The width and/or height of a stop 150 may also vary. Further, the door jamb assembly 100 may have different end work, including, but not necessarily limited to: a straight cut, a miter cut, a coped end cut, and so forth.

In some embodiments, during assembly (e.g., of a door jamb set), the first layer 102 of engineered wood material can be routed into, and a hinge 124 can be attached to the door jamb using fasteners (e.g., screws 126) connected to the second layer 106 of wood material. However, routing through a door jamb assembly 100 during assembly is provided by way of example and is not meant to limit the present disclosure. In other embodiments, a door jamb assembly 100 may be machined/finished (e.g., for hinges 124) prior to sale and/or assembly as a door jamb set. The door jamb set formed of the door jamb assemblies 100 can include the door 122, and the pre-hung door can be attached to the door opening by fastening (e.g., nailing or screwing) through the flat of the jamb, i.e., through the first layer 102 of engineered wood material, through the second layer 106 of wood material, and into the door rough opening.

In some embodiments, when the first layer 102 of engineered wood material is molded from a slurry and/or pressed from a flat composite panel, a stop 150 can be formed from a portion of the slurry and/or pressed panel which is less compressed than the remainder of the first layer 102 of engineered wood material. In some embodiments, the stop 150 can be formed from a loose mat and binding agent/resin/wax arrangement, where the raw material mat thickness is increased in the area of the stop. Further, in some embodiments, the stop 150 can include interior strengthening/stabilizing features, including, but not necessarily limited to: latticing, honeycombing, cross-bracing, and so forth. These features may also be formed of slurry or panel material that is less compressed than the remainder of the first layer 102 of engineered wood material. Further, such features may be formed of separate material glued or otherwise attached to the first layer 102 of engineered wood material. In some embodiments, the interior of the stop 150 may also be corrugated (e.g., in the manner of cardboard).

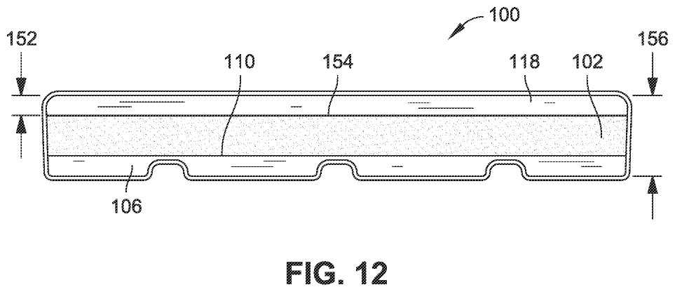

With reference to FIG. 12, in some embodiments, a door jamb assembly 100 can also have a third layer 118 of wood material having a third, generally rectangular cross-sectional thickness 152. In embodiments of the disclosure, the third layer 118 is connected (e.g., bonded, joined) to the first layer 102 at another planar interface 154 (e.g., opposite the planar interface 110). As previously described with reference to the second layer 106 of wood material, the third layer 118 of wood material can be laminated lumber (e.g., LVL), milled lumber material (e.g., pine wood such as Radiata Pine, Poplar, Hemlock, Lauan), and so forth. In some embodiments, the third layer 118 can be the same or similar material or materials as the second layer 106 and/or can be different wood material(s). In some embodiments, the third layer 118 of wood material can include multiple segments fastened together (e.g., finger-jointed wood), particle board, fiberboard, and so forth. The third layer 118 of wood material can be glued (e.g., using an adhesive binder or another adhesive) to the first layer 102 of engineered wood material at the planar interface 154. A press or other equipment may be used to force the first, second, and third layers 102, 106, and 118 together during the gluing process. By way of example, a process for laminating the first layer 102 of engineered wood material and the second and third layers 106 and 118 of wood material together can include cleaning the surfaces of dust and debris, e.g., at surfaces that form the planar interfaces 110 and 154. The surfaces can also be checked to ensure the surfaces to be joined are smooth and free of voids. Then, one or more of the surfaces to be joined can be coated with glue and/or another adhesive, and finally, even pressure can be applied to both materials, e.g., using a press or another pressing device.

Together, the first layer 102, the second layer 106, and the third layer 118 have a total thickness 156. As described herein, the combined, generally rectangular cross-sectional thicknesses 108 and 152 of the second layer 106 and the third layer 118 may be greater than or equal to at least about twenty percent (20%) of the total thickness 156 of the first layer 102, the second layer 106, and the third layer 118. In some embodiments, the combined, generally rectangular cross-sectional thicknesses 108 and 152 can be greater than or equal to about forty percent (40%) of the total thickness 156. For instance, the combined, generally rectangular cross-sectional thicknesses 108 and 152 can be greater than about sixty percent (60%) of the total thickness 156, greater than about eighty percent (80%) of the total thickness 156, and so on. In example embodiments where there is a second layer 106 and a third layer 118, the layers 106 and 118 may have at least approximately the same thickness. In other embodiments, the layers 106 and 118 may not necessarily have the same or similar thickness.

While the description herein has detailed door jamb assemblies 100 including jambs and stops 150 for interior doorway applications with some specificity, it is noted that these particular trim molding applications are provided by way of example and are not meant to limit the present disclosure. In other embodiments, the systems, techniques, and apparatus described herein can be used for various other interior trim molding applications, including, but not necessarily limited to, interior millwork applications such as base moldings, case moldings, crown moldings, etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A blended trim molding assembly comprising:
a first layer of engineered wood material having a first, generally rectangular cross-sectional thickness; and
a second layer of wood material having a second, generally rectangular cross-sectional thickness, the second layer of wood material joined to the first layer of engineered wood material at a planar interface, the first layer of engineered wood material and the second layer of wood material having a total thickness, the first, generally rectangular cross-sectional thickness greater than or equal to at least about ten percent (10%) of the total thickness of the first layer of engineered wood material and the second layer of wood material.

2. The blended trim molding assembly as recited in claim 1, wherein the second layer of wood material is glued to the first layer of engineered wood material.

3. The blended trim molding assembly as recited in claim 1, wherein the first, generally rectangular cross-sectional thickness is greater than or equal to at least about fifty percent (50%) of the total thickness of the first layer of engineered wood material and the second layer of wood material.

4. The blended trim molding assembly as recited in claim 1, wherein the blended trim molding assembly is configured as a flat door jamb.

5. The blended trim molding assembly as recited in claim 1, wherein the first layer of engineered wood material comprises medium-density fiberboard.

6. The blended trim molding assembly as recited in claim 1, wherein the second layer of wood material comprises laminated lumber.

7. The blended trim molding assembly as recited in claim 1, wherein the second layer of wood material comprises milled lumber material.

8. The blended trim molding assembly as recited in claim 1, wherein the second layer of wood material comprises at least one of a plurality of segments fastened together, particle board, or fiberboard.

9. The blended trim molding assembly as recited in claim 1, further comprising a third layer of wood material having a third, generally rectangular cross-sectional thickness, the third layer of wood material joined to the first layer of engineered wood material at a second planar interface opposite the planar interface.

10. A method of forming a blended trim molding assembly, the method comprising:
forming a first layer of engineered wood material having a first, generally rectangular cross-sectional thickness;
forming a second layer of wood material having a second, generally rectangular cross-sectional thickness; and
joining the second layer of wood material to the first layer of engineered wood material at a planar interface, the first layer of engineered wood material and the second layer of wood material having a total thickness, the first, generally rectangular cross-sectional thickness greater than or equal to at least about ten percent (10%) of the total thickness of the first layer of engineered wood material and the second layer of wood material.

11. The method as recited in claim 10, wherein the second layer of wood material is glued to the first layer of engineered wood material.

12. The method as recited in claim 10, wherein the first, generally rectangular cross-sectional thickness is greater than or equal to at least about fifty percent (50%) of the total thickness of the first layer of engineered wood material and the second layer of wood material.

13. The method as recited in claim 10, wherein the blended trim molding assembly is configured as a flat door jamb.

14. The method as recited in claim 10, wherein the first layer of engineered wood material comprises medium-density fiberboard.

15. The method as recited in claim 10, wherein the second layer of wood material comprises laminated lumber.

16. The method as recited in claim 10, wherein the second layer of wood material comprises milled lumber material.

17. The method as recited in claim 10, wherein the second layer of wood material comprises at least one of a plurality of segments fastened together, particle board, or fiberboard.

18. The method as recited in claim 10, further comprising forming a third layer of wood material having a third, generally rectangular cross-sectional thickness; and joining the third layer of wood material to the first layer of engineered wood material at a second planar interface opposite the planar interface.

19. A blended trim molding assembly comprising:
a first layer of engineered wood material having a first, generally rectangular cross-sectional thickness, the first layer of engineered wood material being fiberboard; and
a second layer of wood material having a second, generally rectangular cross-sectional thickness, the second layer of wood material being lumber, the second layer of wood material glued to the first layer of engineered wood material at a planar interface, the first layer of engineered wood material and the second layer of wood material having a total thickness, the first, generally rectangular cross-sectional thickness greater than or equal to at least about ten percent (10%) of the total thickness of the first layer of engineered wood material and the second layer of wood material.

20. The blended trim molding assembly as recited in claim 19, further comprising a third layer of wood material having a third, generally rectangular cross-sectional thickness, the third layer of wood material joined to the first layer of engineered wood material at a second planar interface opposite the planar interface.
